(19) United States
(12) Patent Application Publication
(10) Pub. No.: US 2016/0092527 A1
(43) Pub. Date: Mar. 31, 2016

(54) DATA PROCESSING APPARATUS AND DATA MAPPING METHOD THEREOF

(71) Applicant: Bitnine Co., LTD., Seoul (KR)

(72) Inventors: Cheol Sun Kang, Seoul (KR); Ki Sung Kim, Seongnam (KR)

(73) Assignee: BITNINE CO., LTD., Seoul (KR)

(21) Appl. No.: 14/868,400

(22) Filed: Sep. 29, 2015

(30) Foreign Application Priority Data
Sep. 30, 2014 (KR) 10-2014-0131662

(51) Int. Cl. G06F 17/30

(52) U.S. Cl. CPC G06F 17/30569; G06F 17/30339; G06F 17/30958; G06F 17/30498

(57) ABSTRACT

Provided are a data processing apparatus and a data mapping method thereof. The data processing apparatus according to an present invention includes: a storage unit adapted to store relational data; a mapping unit adapted to store mapping information for mapping a schema of a relational database having the relational data stored therein to a node or an edge of a graph database; and a control unit adapted to convert the relational data into graph data by the mapping unit. By this configuration, it is possible to easily transfer the data of the relational database into the graph database, query the relational database using a query language used in a graph data model, and visualize the relational database in a graph represented by a node and an edge.

### CROSS-REFERENCE TO PRIOR APPLICATIONS

This application claims priority of Korean Patent Application No. 10-2014-0131662, filed on Sep. 30, 2014, which is hereby incorporated by reference in its entirety.

### TECHNICAL FIELD

The present invention relates to a data processing apparatus and a data mapping method thereof. More particularly, the present invention relates to a data processing apparatus capable of converting a relational database into a graph database, and a data mapping method thereof.

### BACKGROUND ART

A data processing apparatus is adapted to store and process input data, and output a result corresponding to a query input by a user. In particular, when a capacity of the input data is large, various types of databases are used to increase a processing rate and obtain reliable results.

Among these databases, a graph database may be optimized to process semi-structured data which does not observe a structured data model rule connected to a relational database or a different type of data table, such that it may be applied to various fields such as social data, recommendation, and geographic spatial analysis.

In the case of a relational data model used in the relational database, in order to define a schema, there is a need to generate a table describing information of entities and separately make a table storing connection information between the entities.

Further, in the case of the relational data model, in order to define queries, there is a need to describe a join operation for these tables and describe conditions of each join, and in the case of a complicated schema, there is a problem that the queries are complicated and there are a large number of join operations.

In contrast, a graph data model used in the graph database may intuitively represent a reality data in a form of a graph data structure without using the table, and may simply write a query statement without a fixed schema.

However, the relational database and the graph database basically have different structures and units used to store the data, and therefore have different query languages. As a result, it is difficult to convert the relational database into the graph database or convert the query language.

### DISCLOSURE

### Technical Problem

Accordingly, it is an object of the present invention to provide a data processing apparatus capable of easily transferring data of a relational database to a graph database, and a data mapping method thereof.

Another object of the present invention is to provide a data processing apparatus capable of querying a relational database using a query language used in a graph data model, and a data mapping method thereof.

Further, another object of the present invention is to provide a data processing apparatus capable of visualizing a relational database in a graph form represented by a node and an edge, and a data mapping method thereof.

### Technical Solution

The above-described objects is achieved by a data processing apparatus, including: a storage unit adapted to store relational data; a mapping unit adapted to store mapping information for mapping a schema of a relational database having the relational data stored therein to a node or an edge of a graph database; and a control unit adapted to control the mapping unit to convert the relational data into graph data.

The control unit may receive a graph query language for querying the graph database and convert the received graph query language into an SQL query language to perform query processing on the relational database.

The control unit may perform a select query on an SQL and a table representing an edge to search for another node connected to a specific node.

The control unit may perform a join operation on the select query to search for a plurality of edges.

The mapping unit may map each record of a first table of the relational data stored in the storage unit to one node, and map a field value of the first table to properties included in the graph data.

The mapping unit may map each record of a second table associated with the first table to one edge.

In addition, the above-described objects also achieved by a data mapping method of a data processing apparatus, including: storing, by a control unit, mapping information for mapping a schema of a relational database to a node or an edge of a graph database; and converting, by the control unit, an input graph query language into a relational query language or converting a relational data into a graph data with reference to the stored mapping information.

### Advantageous Effects

According to the data processing apparatus and the data mapping method thereof of the present invention, it is possible to easily transfer the data of the relational database to the graph database.

According to the data processing apparatus and the data mapping method thereof of the present invention, it is possible to query the relational database using the query language used in the graph data model.

According to the data processing apparatus and the data mapping method thereof of the present invention, it is possible to visualize the relational database in the graph form represented by the node and the edge.

### DESCRIPTION OF DRAWINGS

FIG. 1 is a block diagram illustrating a configuration of a data processing apparatus according to the present invention.

FIG. 2 is a block diagram illustrating a data mapping process by the data processing apparatus according to the present invention.

FIG. 3 is a flow chart illustrating a data mapping method of a data processing apparatus according to the present invention.

### BEST MODE

Hereinafter, a data processing apparatus and a data mapping method thereof according to the present invention will be described in detail with reference to the accompanying drawings.

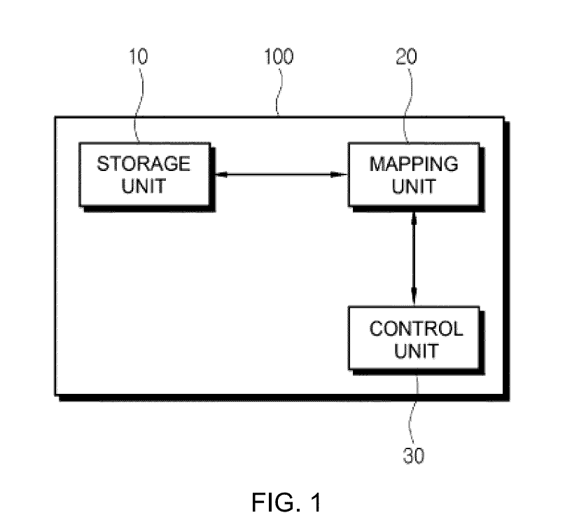

FIG. 1 is a block diagram illustrating a configuration of a data processing apparatus according to the present invention. As illustrated in FIG. 1, a data processing apparatus 100 according to the present invention includes a storage unit 10, a mapping unit 20, and a control unit 30.

The storage unit 10 is adapted to store relational data. The storage unit 10 according to the present invention is adapted to store the relational data in a form of a relational database for storing large-capacity data.

The mapping unit 20 is adapted to store mapping information for mapping a schema of the relational database having the relational data stored therein to a node or an edge of a graph database.

In detail, the mapping unit 20 according to the present invention stores the schema of the relational database as a node or an edge of a graph data model using a property graph model. By using this, the mapping unit 20 matches a portion to be converted into the node or the edge among the schemas of the relational database with the corresponding node or edge and stores the same.

Herein, the node may include a node identifier (ID) and node properties, in which the node properties may be represented by a primary key of a corresponding entity. A query language input to a database of the data processing apparatus 100 according to the present invention may be written in an SQL form to obtain the properties of the node, in which the SQL may be defined as a view. The identifier of the node according to the present invention may store a unique identifier in an overall graph.

Further, the edge may be represented as a pair of primary keys of in and out entities, and the query language input to the database of the data processing apparatus 100 may be written in the SQL form to obtain the properties of the edge, in which the SQL may be defined as the view.

Each node and edge included in graph data may be grouped as a label, and one node and edge may simultaneously belong to a plurality of labels. Further, the node and the edge which are not grouped as the label may be present.

As an example in which the data processing apparatus 100 according to the present invention maps the relational data to the node, in the case of query languages referred to select ID as node_id, name as p_name, age as p_age, and gender as p_gender from person, each row of the person table is mapped to one node, in which the node has properties of a name, an age, and a gender.

Further, as an example in which the data processing apparatus 100 according to the present invention maps the relational data to the edge, in the case of the query languages referred to select ID1 and ID2 from friends, each tuple of the friends table is mapped to one edge, and a node ID of the edge is extracted from a column of ID1 and ID2.

The control unit 30 is adapted to convert the relational data into the graph data by the mapping unit 20 or receive a graph query language and convert the received graph query language into a relational query language. The control unit 30 according to the present invention may be implemented as a microcomputer and software for driving the same.

The control unit 30 according to the present invention may map table information of the relational database to a graph model by using the mapping information stored in the mapping unit 20 to convert the same, and may convert the graph query language into an SQL query language to request the relational database.

Thereby, the data processing apparatus 100 according to the present invention may convert the relational database into the graph database, and may directly transfer a query to the relational database using an intuitive graph query language.

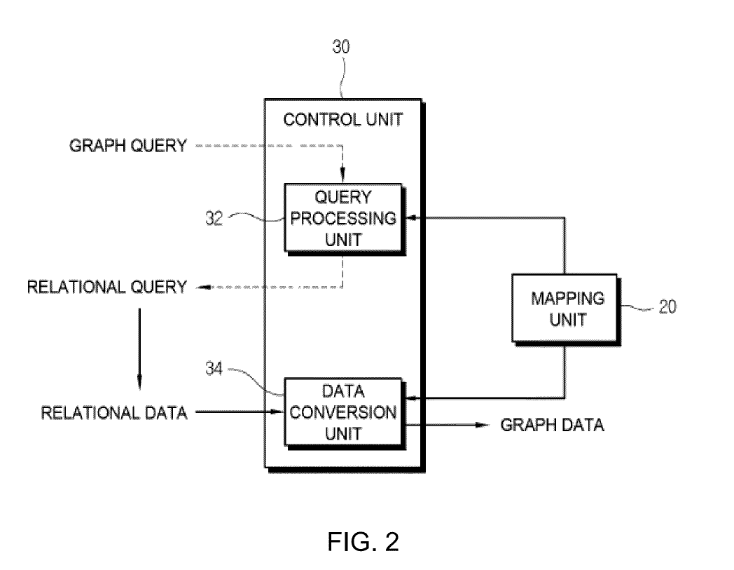

Hereinafter, a data mapping process of the data processing apparatus according to the present invention will be described with reference to FIG. 2. As illustrated in FIG. 2, a query processing unit 32 according to the present invention refers to the mapping information stored in the mapping unit 20 to convert the graph query language into an SQL query which is the relational query language, and a data conversion unit 34 refers to the mapping information stored in the mapping unit 20 to convert the relational data into the graph data.

The query processing unit 32 is adapted to process a graph query using a graph search algorithm, and basically search for another node connected to a specific node. The query processing unit 32 according to the present invention processes the graph query on the relational database with reference to the mapping information stored in the mapping unit 20, thereby intuitively and easily performing the query processing on the relational database. The query processing unit 32 according to the present invention may receive the graph query language including a cypher. A property graph data model has characteristics that it may define a pair of key and value in the node and the edge included in the graph data. By these characteristics, it is possible to directly specify information that should be expressed by another method such as a resource description framework (RDF), simple protocol and RDF query language (SPARQL), or the like.

The query processing unit 32 according to the present invention performs a select query on the SQL query language and a table representing an edge between other nodes connected to the specific node with reference to the mapping information stored in the mapping unit 20. Herein, the control unit 30 preferably performs a join operation on the select query to search for a plurality of edges.

Thereby, it is possible to convert the graph query language into the relational query language, and convert the relational data into the graph data.

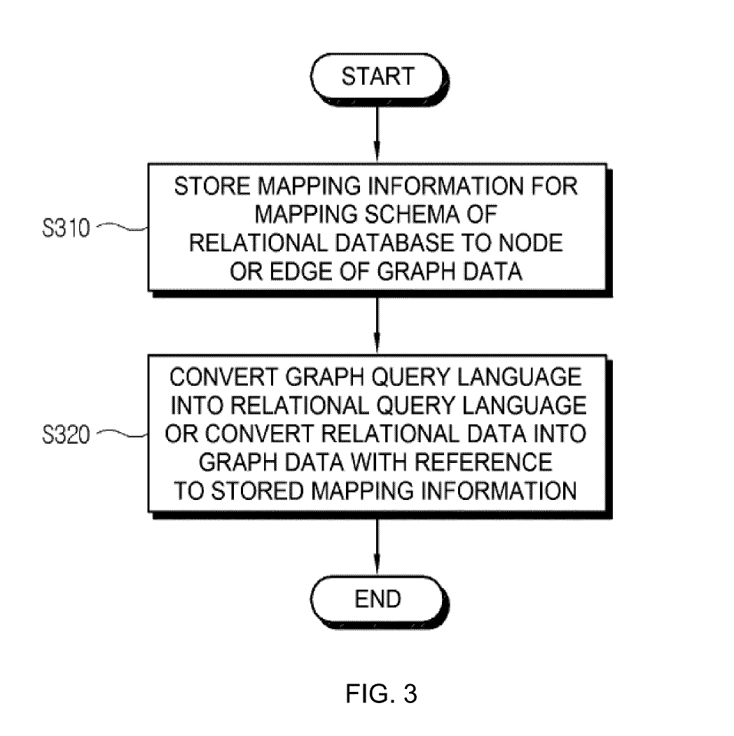

Hereinafter, a data mapping method of the data processing apparatus according to the present invention will be described with reference to FIG. 3.

First, the control unit 30 stores the mapping information for mapping the schema of the relational database to the node or the edge of the graph database (S310). In step S310, a portion to be converted into the node or the edge among the schemas of the relational database may matched with the corresponding node or edge to be stored, in which it is preferable to map each record of a first table of the relational data stored in the storage unit 10 to one node and a field value of the first table is mapped to the properties included in the graph data, and map each record of a second table associated with the first table to one edge.

Next, the control unit 30 converts the input graph query language into the relational query language or convert the relational data into the graph data with reference to the mapping information stored in step S310 (S320). In this case, the input graph query language is a query language for searching for the properties of a specific node or edge, and may be converted into the relational query language representing an edge for searching for another node connected to the specific node to perform the select query on the table. In step S320, it is preferable that the input graph query language includes a query language for the property graph data model.

Further, in step S320, the control unit 30 may map each row of the table of the relational data to one node or edge to convert the relational data into the graph data.

Hereinabove, the present invention is described in detail with reference to the exemplary embodiments, but the present invention is not limited thereto and may be variously modified within a scope of claims.

### DESCRIPTION OF REFERENCE NUMERALS

10: Storage unit 20: Mapping unit

30: Control unit 32: Query processing unit

34: Data conversion unit 100: Data processing apparatus

What is claimed is:

1. A data processing apparatus, comprising:
a storage unit adapted to store relational data;
a mapping unit adapted to store mapping information for mapping a schema of a relational database having the relational data stored therein to a node or an edge of a graph database; and
a control unit adapted to control the mapping unit to convert the relational data into graph data or convert a graph query language into a relational query language.

2. The data processing apparatus of claim 1, wherein the control unit receives a graph query language for querying the graph database and converts the received graph query language into an SQL query language to perform query processing on the relational database.

3. The data processing apparatus of claim 2, wherein the control unit performs a select query on an SQL and a table representing an edge to search for another node connected to a specific node.

4. The data processing apparatus of claim 3, wherein the control unit performs a join operation on the select query to search for a plurality of edges.

5. The data processing apparatus of claim 2, wherein the graph query language includes a query language for a property graph data model.

6. The data processing apparatus of claim 1, wherein the mapping unit maps each record of a first table of the relational data stored in the storage unit to one node, and maps a field value of the first table to properties included in the graph data.

7. The data processing apparatus of claim 6, wherein the mapping unit maps each record of a second table associated with the first table to one edge.

8. A data mapping method of a data processing apparatus, comprising:
storing, by a control unit, mapping information for mapping a schema of a relational database to a node or an edge of a graph database; and
converting, by the control unit, an input graph query language into a relational query language or converting a relational data into a graph data with reference to the stored mapping information.
